(19) United States
(12) Patent Application Publication
(10) Pub. No.: US 2012/0268576 A1
(43) Pub. Date: Oct. 25, 2012

(54) ELECTRONIC APPARATUS, DISPLAY CONTROL METHOD AND RECORDING MEDIUM

(76) Inventor: Atsushi Watanabe, Ome-shi (JP)

(21) Appl. No.: 13/398,652

(22) Filed: Feb. 16, 2012

(30) Foreign Application Priority Data
Apr. 19, 2011 (JP) 2011-093415

(51) Int. Cl. H04N 13/04

(52) U.S. Cl. 348/54; 348/51; 348/E13.075

(57) ABSTRACT

According to one embodiment, an electronic apparatus includes a display with a screen, an area of a part of the screen being settable in one of a three-dimensional video display mode of displaying three-dimensional video and a two-dimensional video display mode of displaying two-dimensional video. The apparatus further includes a detection module, a switch module, and a video display control module. The detection module is configured to detect a variation of a range of the area. The switch module is configured to switch the area to the two-dimensional video display mode, in a case where the detection module detects the variation of the range of the area when the area is set in the three-dimensional video display mode.

### CROSS-REFERENCE TO RELATED APPLICATIONS

This application is based upon and claims the benefit of priority from prior Japanese Patent Application No. 2011-093415, filed Apr. 19, 2011, the entire contents of which are incorporated herein by reference.

### FIELD

Embodiments described herein relate generally to an electronic apparatus which reproduces three-dimensional (3D) video content, and a display control method.

### BACKGROUND

In recent years, there are provided various video display apparatuses for viewing three-dimensional (3D) video. An example of such video display apparatuses is a video display apparatus by a naked-eye stereopsis method (naked-eye 3D method). In the naked-eye stereopsis method, for example, a left-eye video image and a right-eye video image are simultaneously displayed on a liquid crystal display (LCD) (space-division method), and the directions of emission of light rays corresponding to the pixels in these video images are controlled by a lenticular lens or a parallax barrier, which is disposed on the display surface of the LCD. Thereby, a user can view pixels of the left-eye video image by the left eye and pixels of the right-eye video image by the right eye, thus being able to perceive 3D video (stereoscopic video). 3D video is displayed, for example, on an area which is set in accordance with designation by the user.

Conventionally, the area which displays 3D video (stereoscopic video) is preset, for example, in accordance with the position or size designated by the user. The position of the area which displays 3D video (stereoscopic video) is fixed, and it is not assumed that this position is varied while the 3D video is being displayed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus according to an embodiment.

FIG. 2 is an exemplary view illustrating the system configuration of a personal computer in the embodiment.

FIG. 3 is an exemplary block diagram illustrating the functional configuration of a video content reproduction program in the embodiment.

FIG. 4 is an exemplary flow chart illustrating the procedure of a video reproduction process in the embodiment.

FIG. 5 is an exemplary flow chart illustrating the procedure of a video display area moving process in the embodiment.

FIG. 6 is an exemplary view illustrating a screen for describing the video display area moving process in the embodiment.

FIG. 7 is an exemplary view illustrating a screen for describing the video display area moving process in the embodiment.

FIG. 8 is an exemplary view illustrating a screen for describing the video display area moving process in the embodiment.

FIG. 9 is an exemplary view illustrating a screen for describing the video display area moving process in the embodiment.

FIG. 10 is an exemplary view illustrating a data structure of 3D video data in the embodiment.

FIG. 11 is an exemplary view illustrating a screen for describing the video display area moving process in the embodiment.

FIG. 12 is an exemplary flow chart illustrating the procedure of a video display area size varying process in the embodiment.

FIG. 13 is an exemplary view illustrating a screen for describing the video display area size varying process in the embodiment.

FIG. 14 is an exemplary view illustrating a screen for describing the video display area size varying process in the embodiment.

FIG. 15 is an exemplary view illustrating a screen for describing the video display area size varying process in the embodiment.

### DETAILED DESCRIPTION

Various embodiments will be described hereinafter with reference to the accompanying drawings.

In general, according to one embodiment, an electronic apparatus comprises a display with a screen, an area of a part of the screen being settable in one of a three-dimensional video display mode of displaying three-dimensional video and a two-dimensional video display mode of displaying two-dimensional video. The apparatus further comprises a detection module, a switch module, and a video display control module. The detection module is configured to detect a variation of a range of the area. The switch module is configured to switch the area to the two-dimensional video display mode, in a case where the detection module detects the variation of the range of the area when the area is set in the three-dimensional video display mode. The video display control module is configured to display, on the area, video corresponding to one of the three-dimensional video display mode and the two-dimensional video display mode.

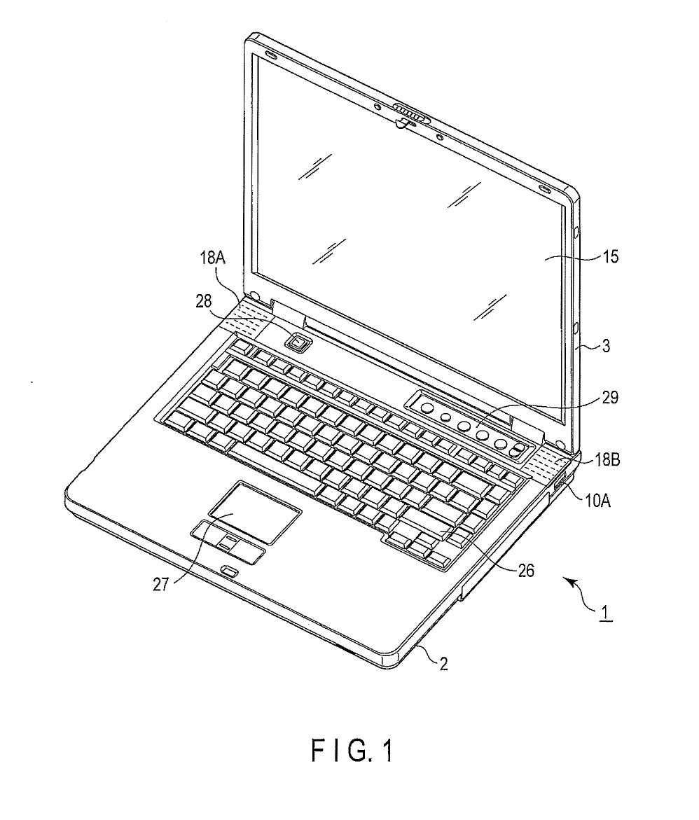

FIG. 1 is an exemplary perspective view showing the external appearance of an electronic apparatus according to an embodiment. The electronic apparatus is realized, for example, as a notebook-type personal computer 1. In addition, this electronic apparatus may be realized as a TV receiver, a recorder for storing video data (e.g. a hard disk recorder or a DVD recorder), a tablet PC, a slate PC, a PDA (personal digital assistant), a car navigation apparatus, a smartphone, etc.

As shown in FIG. 1, the personal computer 1 includes a computer main body 2 and a display unit 3.

A three-dimensional display (3D display) 15 is built in the display unit 3. The display unit 3 is attached to the computer main body 2 such that the display unit 3 is rotatable between an open position where the top surface of the computer main body 2 is exposed, and a closed position where the top surface of the computer main body 2 is covered.

In addition, the 3D display 15 includes an LCD (liquid crystal display) 15A and a lens unit 15B. The lens unit 15B is laid over the display surface of the LCD 15A. The lens unit 15B includes a plurality of lens functions for emitting, in predetermined directions, a plurality of light rays corresponding to a plurality of pixels included in a video image that is displayed on the LCD 15A. The lens unit 15B is, for example, a liquid crystal GRIN (gradient index) lens which can electrically switch the lens functions that are necessary for 3D video display. In the liquid crystal GRIN lens, a refractive index distribution is created by electrodes with use of a planar liquid crystal layer. Thus, for example, a designated area in the screen can display 3D video, and the other area can display two-dimensional (2D) video. Specifically, by varying the refractive index of the lens between the area which displays 3D video and the area which displays 2D video, a 3D video display mode for displaying 3D video and a 2D video display mode for displaying 2D video can be switched partly within the screen. In the area which is set in the 3D video display mode, the refractive index is varied so that 3D video including left-eye video and right-eye video, which is to be displayed in this area, may have a parallax corresponding to an eye separation distance or a viewing distance. In the area which is set in the 2D video display mode, the refractive index is varied so that 2D video, which is to be displayed in this area, may be displayed as such, without being refracted. In the 3D display 15, each of a plurality of areas having arbitrary positions and sizes, which are set in the screen, can be set in one of the 3D video display mode and 2D video display mode.

The 3D display 15 displays left-eye video and right-eye video on the area of the 3D video display mode, and displays 2D video on the area of the 2D video display mode. Thus, the user can perceive 3D video when viewing the area in the screen, which is set in the 3D video display mode, and can perceive 2D video when viewing the area in the screen, which is set in the 2D video display mode.

The computer main body 2 has a thin box-shaped housing. A keyboard 26, a power button 28 for powering on/off the personal computer 1, an input operation panel 29, a pointing device (touch pad) 27, and speakers 18A and 18B are disposed on the top surface of the housing of the computer main body 2. Various operation buttons are provided on the input operation panel 29. The buttons include operation buttons for controlling a TV function (viewing, recording and reproduction of recorded broadcast program data/video data).

An antenna terminal 10A for TV broadcast is provided, for example, on a right-side surface of the computer main body 2. In addition, an external display connection terminal supporting, e.g. the HDMI (high-definition multimedia interface) standard is provided, for example, on a rear surface of the computer main body 2. This external display connection terminal is used for outputting video data (moving picture data) included in video content data, such as broadcast program data, to an external display.

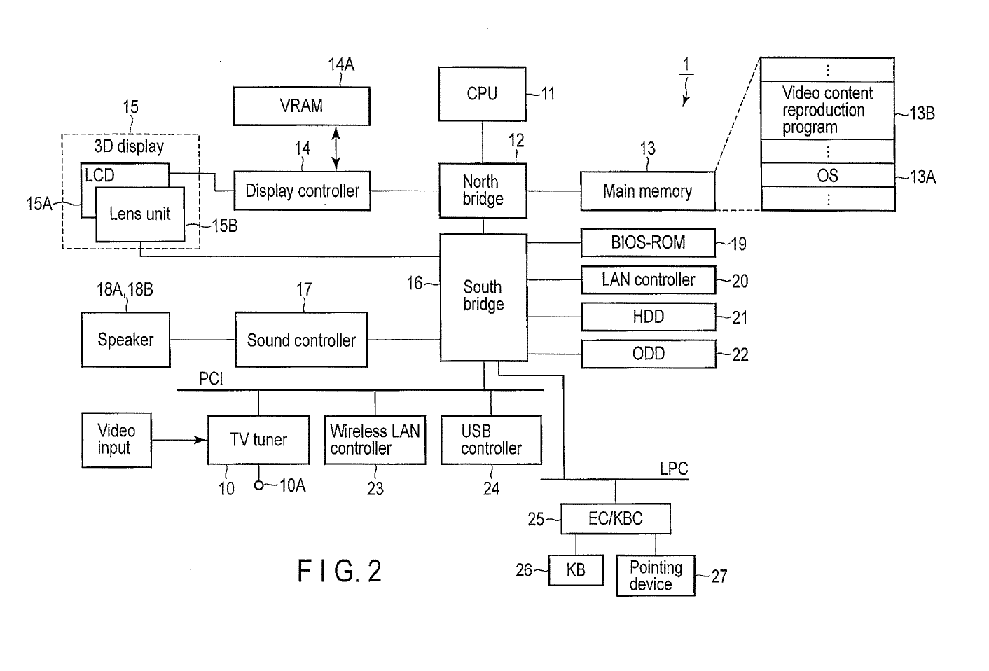

FIG. 2 shows the system configuration of the personal computer 1.

The personal computer 1, as shown in FIG. 2, includes a CPU 11, a north bridge 12, a main memory 13, a display controller 14, a video memory (VRAM) 14A, 3D display 15, a south bridge 16, a sound controller 17, speakers 18A and 18B, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, keyboard (KB) 26, pointing device 27, and a TV tuner 10.

The CPU 11 is a processor for controlling the operation of the personal computer 1. The CPU 11 executes an operating system (OS) 13A and an application program, such as a video content reproduction program 13B, which are loaded from the HDD 21 into the main memory 13. The video content reproduction program 13B is software having a function for viewing video content data. The video content reproduction program 13B executes a live reproduction process for viewing broadcast program data which is received by the TV tuner 10, a recording process for recording the received broadcast program data in the HDD 21, a reproduction process for reproducing broadcast program data/video data which is recorded in the HDD 21, and a reproduction process for reproducing video content data which is received via a network. In addition, the video content reproduction program 13B can reproduce video content data which is stored in storage media such as a DVD, or in a storage device such as a hard disk.

Further, the video content reproduction program 13B includes a function for reproducing 3D video. The video content reproduction program 13B converts 2D video, which is included in video content data, to 3D video in real time, and displays the 3D video on the screen (the screen of the 3D display) 15. The video content reproduction program 13B can 2D-3D convert various video content data (e.g. broadcast program data, video data stored in storage media or storage devices, or video data received from a server on the Internet).

For the display of 3D video, use may be made of the 3D display 15 by a naked-eye stereopsis method (e.g. an integral imaging method, a lenticular method, or a parallax barrier method). The user can perceive 3D video by the naked eyes by viewing video which is displayed on the 3D display 15 by the naked-eye stereopsis method.

Besides, the video content reproduction program 13B has a display control function of changing display from 3D video to 2D video in accordance with an event which occurs, while 3D video is being reproduced, to vary the range of the area which displays 3D video. Examples of the event which varies the range of the area include a movement of the area and a variation of the size of the area.

The area, which displays 3D video by the naked-eye stereopsis method, is designated, for example, by a rectangle by the control of the OS 13A. In general, the area (window), which is set by the OS 13A, can arbitrarily be moved or resized by a user operation. In the present embodiment, a window for displaying 3D video can similarly be moved or resized. When the window, in which 3D video is being reproduced, has been moved or resized, a process with a great load is necessary in order to continuously display the 3D video in real time in accordance with the movement or the variation in size. For example, it is necessary to generate 3D video according to the position or size of the window which is continuously varying, to display the generated 3D video in the window, and to drive the lens unit 15B in accordance with the position or size of the window. It is thus possible that the process for displaying the 3D video fails to follow while the window is being moved or resized, and the video cannot correctly be displayed.

Thus, when an event has occurred to vary the position or size of the window which displays 3D video, the video content reproduction program 13B executes control, by the display control function, so as to change the 3D video to 2D video and display the 2D video, while the position or size of the window is being varied. Then, when the varying of the position or size of the window is terminated, the 3D video is displayed once again. Thereby, even when the position or size of the window, which displays 3D video, is varied, the video can continuously be displayed correctly, with no stress to the user.

Besides, the CPU 11 executes a BIOS (Basic Input/Output System) that is stored in the BIOS-ROM 19. The BIOS is a program for hardware control.

The north bridge 12 is a bridge device which connects a local bus of the CPU 11 and the south bridge 16. The north bridge 12 includes a memory controller which access-controls the main memory 13. The north bridge 12 also has a function of communicating with the display controller 14.

The display controller 14 is a device which controls the LCD 15A that is used as a display of the personal computer 1. A display signal, which is generated by the display controller 14, is sent to the LCD 15A. The LCD 15A displays video, based on the display signal.

The south bridge 16 controls devices on a PCI (Peripheral Component Interconnect) bus and devices on an LPC (Low Pin Count) bus. The south bridge 16 includes an IDE (Integrated Drive Electronics) controller for controlling the HDD 21 and ODD 22, and a memory controller which access-controls the BIOS-ROM 19. The south bridge 16 also has a function of communicating with the sound controller 17 and LAN controller 20.

Furthermore, the south bridge 16 can output to the lens unit 15B a control signal for executing such control as to set each of plural areas in the lens unit 15B in either the 3D video display mode or the 2D video display mode, in accordance with, e.g. a request by the video content reproduction program 13B. In accordance with the control signal which has been output by the south bridge 16, the lens unit 15B varies, for example, the refractive index of that part of the liquid crystal layer, which corresponds to each of the plural areas, thereby setting each area in either the 3D video display mode or the 2D video display mode.

The sound controller 17 is a sound source device and outputs audio data, which is a target of reproduction, to the speakers 18A and 18B. The LAN controller 20 is a wired communication device which executes wired communication of, e.g. the Ethernet (trademark) standard. The wireless LAN controller 23 is a wireless communication device which executes wireless communication of, e.g. the IEEE 802.11 standard. In addition, the USB controller 24 communicates with an external device via a cable of, e.g. the USB 2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of powering on/off the personal computer 1 in accordance with the user's operation.

The TV tuner 10 is a reception device which receives broadcast program data that is broadcast by a television (TV) broadcast signal, and the TV tuner 10 is connected to the antenna terminal 10A. Needless to say, the TV tuner 10 may be configured to receive a TV broadcast signal with use of a built-in antenna. The TV tuner 10 is realized as a digital TV tuner which can receive digital broadcast program data of, e.g. ground digital TV broadcast. In addition, the TV tuner 10 has a function of capturing video data which is input from an external device.

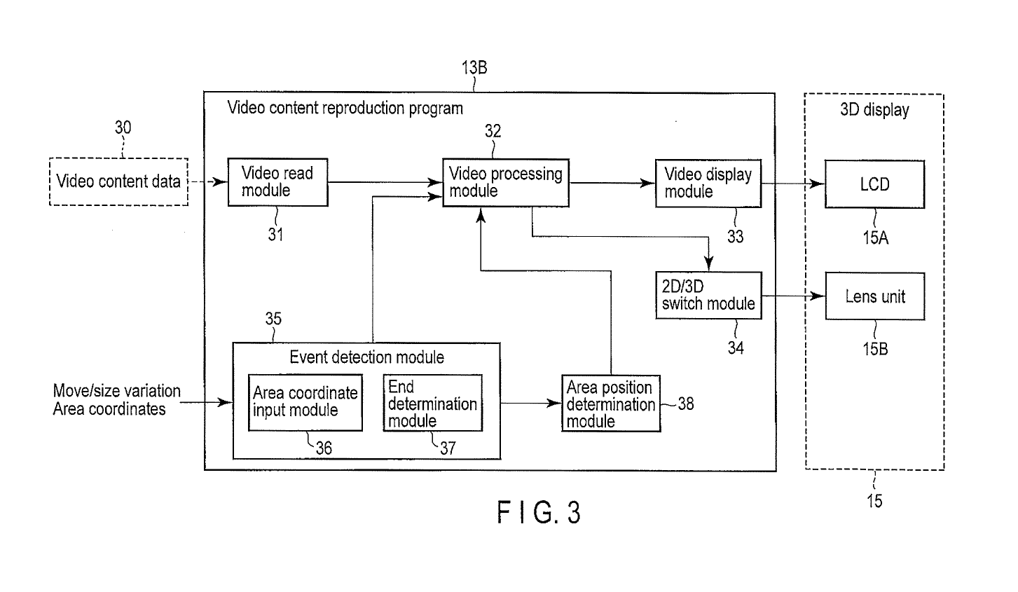

FIG. 3 is a block diagram illustrating an example of the functional configuration of the video content reproduction program 13B. The video content reproduction program 13B has a video reproduction function for reproducing video content data 30 as 3D video or 2D video. In addition, the video content reproduction program 13B has a display control function of changing display from 3D video to 2D video in accordance with an event which occurs, while 3D video is being reproduced, to vary the range of the area which displays 3D video.

The video content reproduction program 13B includes a video read module 31, a video processing module 32, a video display module 33, a 2D/3D switch module 34, an event detection module 35 (an area coordinate input module 36 and an end determination module 37), and an area position determination module 38. The video read module 31, video processing module 32, video display module 33 and 2D/3D switch module 34 realize the video reproduction function. The video processing module 32, event detection module 35, area position determination module 38 and 2D/3D switch module 34 realize the display control function. The structure for the video reproduction function and the structure for the display control function will be described below.

To begin with, the structure for the video reproduction function is described.

The video read module 31 reads out the video content data 30 from, for example, storage media such as a DVD, or from a storage device such as the HDD 21. In the meantime, the video read module 31 may receive the video content data 30 via the TV tuner 10 or LAN controller 20, 23. The video content data 30 includes 2D video data for displaying 2D video, or 3D video data for displaying 3D video. Such video data is, for example, compression-encoded video data (e.g. MPEG (Moving Picture Experts Group) method). In this case, the video data is decoded and then used. In addition, the video content data 30 may include various metadata. The video read module 31 outputs the read-out (received) video content data 30 to the video processing module 32.

In the meantime, 3D video data included in the video content data 30 includes left-eye video data and right-eye video data for 3D video. It is assumed that data structures of 3D video data include, for example, a side-by-side format in which left-eye video data and right-eye video data are arranged in one frame in a right-and-left direction, and a top-and-bottom format in which left-eye video data and right-eye video data are arranged in one frame in a top-and-bottom direction.

The video processing module 32 generates video data by using the video content data 30 which has been output by the video read module 31. Specifically, the video processing module 32 first determines whether video is to be displayed in either the 2D video display mode or the 3D video display mode. For example, when 3D video data is included in the video content data 30, the video processing module 32 determines that video is to be displayed in the 3D video display mode. In addition, the video processing module 32 determines that video is to be displayed in a display mode which is designated by the user. The user selects the video display mode, for example, by using an operation screen including a button for selecting either the 2D video display mode or the 3D video display mode.

When it has been determined that video is displayed in the 3D video display mode and when 3D video data is included in the video content data 30, the video processing module 32 generates left-eye video data and right-eye video data by using the 3D video data. The video processing module 32 requests the 2D/3D switch module 34 to set a video display area in the 3D display 15 in the 3D video display mode. To be more specific, the video processing module 32 outputs to the 2D/3D switch module 34 information (e.g. coordinate information of an upper left apex and a lower right apex of a rectangle) indicative of the video display area (display window) and information indicating that the designated area (i.e. the video display area) is to be set in the 3D video display mode. The video display area is, for example, a window area for displaying video based on the video content data 30. Then, the video processing module 32 outputs to the video display module 33 the coordinate information indicative of the range of the video display area (display window) and the generated left-eye video data and right-eye video data. In the meantime, when the video display area (display window) is at such a position that the video display area does not fall within the display range of the LCD 15A, that is, when the video display area is at such a position that only a part of the video display area is displayed, the coordinate information indicative of a displayable range is output to the video display module 33.

Besides, when it has been determined that video is displayed in the 3D video display mode and when 2D video data is included in the video content data 30, the video processing module 32 executes 2D to 3D conversion of the 2D video data. By the 2D to 3D conversion, a plurality of depths corresponding to a plurality of pixels included in each image frame of the 2D video are estimated, and a plurality of parallaxes corresponding to the estimated plural depths are calculated by taking into account a binocular parallax based on an eye separation distance or a viewing distance. In short, a plurality of parallaxes corresponding to a plurality of pixels included in the image frame are calculated. Based on the calculated parallaxes, the video processing module 32 generates left-eye video data and right-eye video data. The video processing module 32 requests the 2D/3D switch module 34 to set the video display area in the 3D display 15 in the 3D video display mode. Then, the video processing module 32 outputs the generated left-eye video data and right-eye video data to the video display module 33.

In addition, when it has been determined that video is displayed in the 2D video display mode and when 2D video data is included in the video content data 30, the video processing module 32 requests the 2D/3D switch module 34 to set the video display area in the 3D display 15 in the 2D video display mode. Then, the video processing module 32 outputs the 2D video data to the video display module 33.

The 2D/3D switch module 34 switches the video display mode of the video display area in accordance with the request by the video processing module 32. Specifically, the 2D/3D switch module 34 sets the designated area in the designated video display mode, based on the information which has been output by the video processing module 32. For example, when it has been requested by the video processing module 32 that the video display area be set in the 3D video display mode, and when the video display area is currently set in the 2D video display mode, the 2D/3D switch module 34 switches the display mode of the video display area from the 2D video display mode to the 3D video display mode. In addition, when it has been requested by the video processing module 32 that the video display area be set in the 2D video display mode, and when the video display area is currently set in the 3D video display mode, the 2D/3D switch module 34 switches the display mode of the video display area from the 3D video display mode to the 2D video display mode. In the 3D video display mode, that part of the lens unit 15B, which corresponds to the video display area, is controlled so as to have a lens function (refractive index) which is necessary for 3D video display. In the 2D video display mode, that part of the lens unit 15B, which corresponds to the video display area, is controlled so as to have a lens function which is necessary for 2D video display (i.e. so as to display 2D video as such, without being polarized).

The video display module 33 displays video on the video display area in the LCD 15A. Specifically, when left-eye video data and right-eye video data are being output by the video processing module 32, the video display module 33 displays a left-eye video image and a right-eye video image on the video display area in the LCD 15A, by using the left-eye video data and right-eye video data. To be more specific, when the 3D video data has a side-by-side format, the video display module 33 extracts left-eye video data which is present on the left side of a center line which divides one frame into left and right parts, and right-eye video data which is present on the right side of the center line, composites the left-eye video data and right-eye video data, and generates display data for 3D video for displaying left-eye video and right-eye video in one frame. The LCD 15A displays video, based on the display data for 3D video which has been generated by the video display module 33.

In the meantime, when the video display area (display window) is at such a position that the video display area does not fall within the display range of the LCD 15A, that is, when the video display area is at such a position that only a part of the video display area is displayed, coordinate information indicative of a displayable range is output to the video display module 33. In this case, the display data for 3D video is generated by using the 3D video data which corresponds to the coordinate information and corresponds to the part of the video display area. Specifically, since the display data for 3D video is generated by using only a part of the 3D video data, a disordered video image, which is different from the normal 3D video image, would be displayed. Taking this into account, according to the video content reproduction program 13B of the present embodiment, when the video display area is at such a position that the entirety of the video display area does not fall within the display range of the LCD 15A, the video processing module 32 forcibly switches the video display mode to the 2D video display mode, so that 2D video may be displayed. Thereby, the video which is displayed on the video display area is prevented from being disordered.

When 2D video data is being output by the video processing module 32, the video display module 33 displays 2D video on the video display area in the LCD 15A by using the 2D video data.

By the above-described structure for the video reproduction function, the user can view 3D video or 2D video, which is displayed on the 3D display 15 (video display area). In the meantime, when 3D video is displayed on the 3D display 15, the emission directions of pixels of the left-eye video and right-eye video, which is displayed on the video display area in the LCD 15A, are controlled by that part of the lens unit 15B, which corresponds to the video display area. Thereby, the user can stereoscopically perceive the video by the naked eyes.

Next, the structure for the display control function is described.

The event detection module 35 detects the occurrence of an event of varying the range of the video display area (display window), such as an event of moving the position of the video display area or an event of varying the size of the video display area. Specifically, in accordance with the occurrence of the event of movement/size variation of the video display area, the event detection module 35 inputs from the OS 13A the coordinate information (area coordinates) indicative of the range of the varied video display area. While the process of varying the range of the video display area is being executed, the area coordinate input module 36 of the event detection module 35 acquires the coordinate information after the variation of the video display area from the OS 13A, for example, at regular time intervals. The end determination module 37 determines that the movement/size variation of the video display area has been terminated, if no coordinate information is input by the area coordinate input module 36 even after the passage of a predetermined time after the occurrence of the event. In the meantime, for example, when the start and end of the process of movement/size variation of the video display area are notified from the OS 13A, the end determination module 37 may determine the end, based on this notification.

Responding to the occurrence of the event of movement/size variation of the video display area, the event detection module 35 notifies the video processing module 32 of the coordinate information after the variation of the video display area, for example, at regular time intervals, while the process of varying the range of the video display area is being executed. Responding to the notification from the event detection module 35, the video processing module 32 switches the video display mode to the 2D video display mode when the video display area, which is the target of movement/size variation, is currently set in the 3D video display mode, thereby displaying 2D video. Specifically, the video processing module 32 notifies the 2D/3D switch module 34 of the coordinate information (area coordinates) indicative of the range of the varied video display area, and requests the 2D/3D switch module 34 to set the video display area in the 2D video display mode.

When the end determination module 37 has determined that the varying of the range of the video display area is terminated, the area position determination module 38 determines whether the entirety of the varied video display area is included in the display range of the LCD 15A. When the area position determination module 38 determines whether the entirety of the varied video display area is not included in the display range of the LCD 15A, the area position determination module 38 notifies the video processing module 32, thereby displaying 2D video in the video display area.

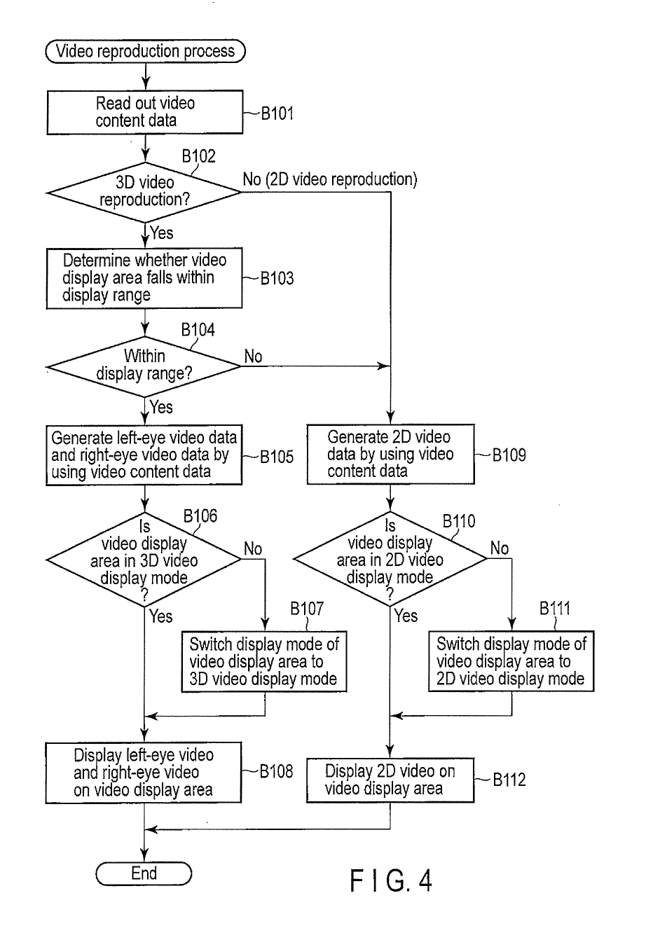

Next, referring to a flow chart of FIG. 4, an example of the procedure of the video reproduction process is described. The video content reproduction program 13B displays 3D video or 2D video on a video display area by using the video content data 30.

To start with, the video read module 31 reads out the video content data 30 from the storage device such as the HDD 21 (block B101). The video content data 30 includes 2D video data or 3D video data. The video read module 31 outputs the read-out video content data 30 to the video processing module 32.

Then, the video processing module 32 determines whether the video content data 30, which has been output by the video read module 31, is reproduced as 3D video or not (block B102). For example, when the video content data 30 includes 3D video data, the video processing module 32 determines that the video content data 30 is reproduced as 3D video. In addition, for example, when it is instructed by the user that the video content data 30 is to be reproduced as 3D video, the video processing module 32 determines that the video content data 30 is reproduced as 3D video.

When it has been determined that the video content data 30 is reproduced as 3D video (YES in block B102), the video processing module 32 determines whether the entirety of the present video display area falls within the display range of the LCD 15A (block B103).

When it is determined that the entirety of the present video display area falls within the display range of the LCD 15A (YES in block B104), the video processing module 32 generates left-eye video data and right-eye video data by using the video content data 30 (block B105). Specifically, when the video content data 30 includes 3D video data, the video processing module 32 generates left-eye video data and right-eye video data by using the 3D video data. In addition, when the video content data 30 includes 2D video data, the video processing module 32 generates left-eye video data and right-eye video data by 2D to 3D converting the 2D video data.

Then, the 2D/3D switch module 34 determines whether the video display area, on which the left-eye video data and right-eye video data are displayed, is set in the 3D video display mode (block B106). When the video display area is set in the 3D video display mode (YES in block B106), the video display module 33 displays left-eye video and right-eye video on the video display area by using the left-eye video data and right-eye video data (block B108).

In addition, when the video display area is not set in the 3D video display mode (NO in block B106), that is, when the video display area is set in the 2D video display mode, the 2D/3D switch module 34 switches the display mode of the video display area (that part of the lens unit 15B, which corresponds to the video display area) from the 2D video display mode to the 3D video display mode (block B107). Then, the video display module 33 displays left-eye video and right-eye video on the video display area by using the left-eye video data and right-eye video data (block B108).

On the other hand, when it has been determined that the entirety of the present video display area does not fall within the display range of the LCD 15A (NO in block B104), the video processing module 32 displays 2D video on the video display area in a manner as described below, even if the video content data 30 includes 3D video data or the user has instructed that the video content data 30 is to be reproduced as 3D video.

Specifically, the video processing module 32 generates 2D video data by using the video content data 30 (block B109). When the video content data 30 includes 3D video data, the video processing module 32 generates 2D video data by using, for example, either left-eye video data or right-eye video data. Then, the 2D/3D switch module 34 determines whether the video display area is set in the 2D video display mode (block B110). When the video display area is set in the 2D video display mode (YES in block B110), the video display module 33 displays 2D video on the video display area 40 by using the 2D video data (block B111).

Meanwhile, when the video display area is not set in the 2D video display mode (NO in block B110), that is, when the video display area is set in the 3D video display mode, the 2D/3D switch module 34 switches the display mode of the video display area from the 3D video display mode to the 2D video display mode (block B111). Then, the video display module 33 displays 2D video on the video display area 40 by using the 2D video data (block B112).

As has been described above, when the entirety of the video display area does not fall within the display range of the LCD 15A, the video display area is set in the 2D video display mode and 2D video is displayed. Thereby, the displayed video is prevented from being disordered.

In the meantime, when it has been determined that the video content data 30 is not to be reproduced as 3D video (NO in block B102), 2D video is displayed on the video display area in the same manner as described above (block 8109 to block B112).

By the above-described process, 2D video or 3D video is displayed on the video display area 40 by using the video content data 30. The video content data 30 is successively reproduced on a frame-by-frame basis.

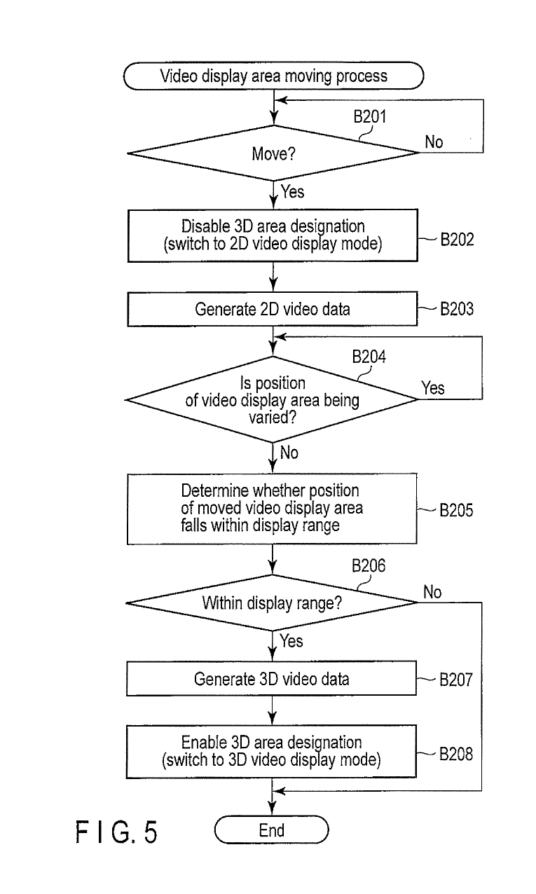

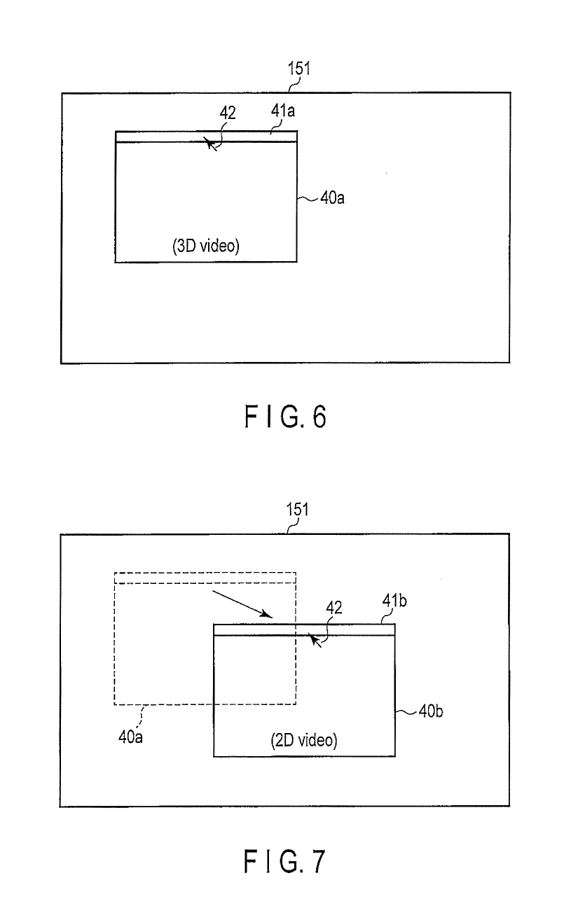

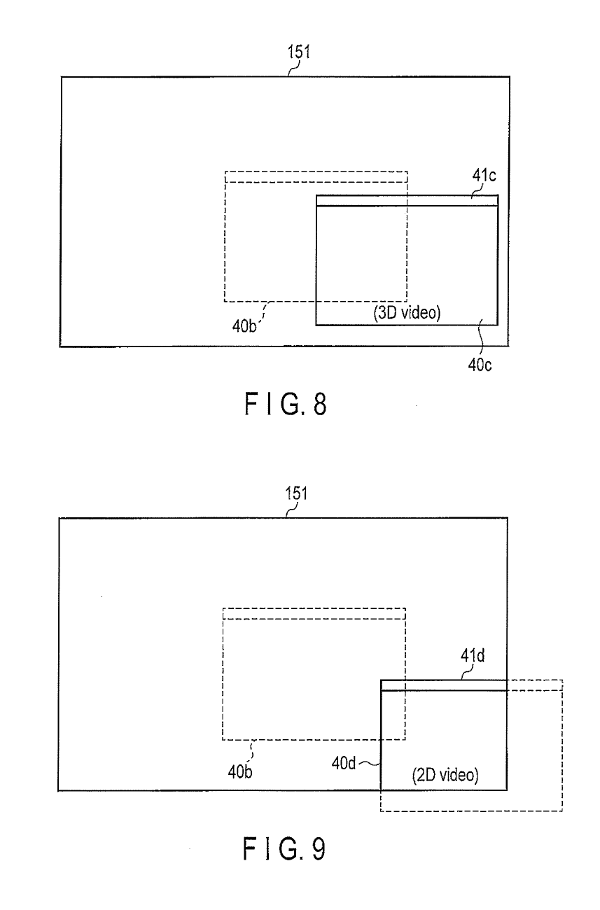

Next, referring to a flow chart of FIG. 5, a description is given of an example of the procedure of a video display area moving process. FIG. 6, FIG. 7, FIG. 8 and FIG. 9 show screen examples of the LCD 15A for describing the video display area moving process.

In the screen example of FIG. 6, a video display area 40a for displaying video is set on a partial area of a screen 151. The video display area 40a can be set in either a 3D video display mode for displaying 3D video or a 2D video display mode for displaying 2D video. 2D video (2D image) is displayed on the area other than the video display area 40a.

The screen 151 displays a pointer 42 which is moved by an operation of the pointing device 27 (tablet, mouse, etc.) by the user. The position of the video display area 40a can be moved by setting the pointer 42 at a predetermined area (e.g. title bar 41a) that is added to the video display area 40a, and dragging this predetermined area.

It is now assumed that the video display area 40a is set in the 3D video display mode, and 3D video is displayed on the video display area 40a. When the move of the video display area 40a is instructed by the user's operation of the pointing device 27, the OS 13A varies the display position of the video display area 40a. In addition, with the movement of the video display area 40a, the area coordinate input module 36 of the video content reproduction program 13B acquires coordinate information indicative of the range of the video display area 40a from the OS 13A.

If the event detection module 35 detects the movement of the video display area 40a by the acquisition of the coordinate information by the area coordinate input module 36 (YES in block B201), the event detection module 35 notifies the video processing module 32 of the occurrence of the move event of the video display area 40a and the coordinate information.

Responding to the notification from the event detection module 35, the video processing module 32 instructs the 2D/3D switch module 34 to disable the 3D area designation of the video display area 40a (block B202). In accordance with the instruction from the video processing module 32, the 2D/3D switch module 34 switches the video display mode of that area of the lens unit 15B, which corresponds to the video display area 40a, to the 2D video display mode.

While the video display area 40a is being moved, the event detection module 35 acquires the varied coordinate information from the OS 13A, for example, at regular time intervals, and notifies the video processing module 32 of the acquired coordinate information. The video processing module 32 generates 2D video data and outputs the 2D video data to the video display module 33, and outputs the coordinate information, which is input at regular time intervals, to the video display module 33 (block B203). Thus, as shown in FIG. 7, the video display module 33 can display 2D video on a video display area 40b which is being moved.

FIG. 7 shows a screen example at a time when the video display area 40a is being moved. As shown in FIG. 7, if the move of the video display area 40a and title bar 41b is started in accordance with the operation of moving the pointer 42, 2D video is displayed on the video display area 40b which is being moved.

When the end determination module 37 of the event detection module 35 determines that the move of the video display area 40a and title bar 41b is stopped (YES in block B204), the end determination module 37 notifies the video processing module 32 and area position determination module 38. The area position determination module 38 determines whether the position of the moved video display area is included in the display range of the LCD 15A (block B205).

For example, as shown in FIG. 8, when a video display area 40c and a title bar 41c have been moved in accordance with the operation of moving the pointer 42 and the movement has been terminated at the position where the entirety of the video display area 40c is displayed on the screen 151, the area position determination module 38 determines that the position of the moved video display area falls within the display range of the LCD 15A (YES in block B206).

In this case, responding to notification from the area position determination module 38, the video processing module 32 generates 3D video data and outputs the 3D video data to the video display module 33, and outputs the coordinate information of the moved video display area 40c to the video display module 33 (block B207). In addition, the video processing module 32 instructs the 2D/3D switch module 34 to enable 3D area designation of the video display area 40c. In accordance with the instruction from the video processing module 32, the 2D/3D switch module 34 switches the video display mode of that area of the lens unit 15B, which corresponds to the video display area 40c, to the 3D video display mode (block B208). Accordingly, as shown in FIG. 8, the video display module 33 can display 3D video on the moved video display area 40c.

On the other hand, as shown in FIG. 9, when a video display area 40d and a title bar 41d have been moved in accordance with the operation of moving the pointer 42 and the movement has been terminated at the position where the entirety of the video display area 40d is not displayed on the screen 151, the area position determination module 38 determines that the position of the moved video display area 40d does not fall within the display range of the LCD 15A (NO in block B206). In this case, the area position determination module 38 notifies the video processing module 32 that the video display area 40d falls out of the display range of the LCD 15A. While keeping the video display area 40d in the 2D video display mode, the video processing module 32 causes the video display module 33 to display 2D video on the video display area 40d. The video display module 33 receives the coordinate information indicative of a displayable range from the video processing module 32, and displays 2D video on the video display area 40d by using 2D video data corresponding to this displayable range.

As has been described above, when the position of the video display area 40a, on which 3D video is displayed, is moved, the video display mode of the video display area 40a is switched to the 2D video display mode, and 2D video is displayed on the video display area 40b which is being moved. When 2D video is displayed, a process with a great load, such as driving of the lens unit 15B or generation of 3D video data, is needless, so the video displayed on the video display area 40b is not disordered. In short, correct video can continuously be displayed on the video display area 40b which is being moved.

In the above description, when the entirety of the video display area 40d is not included in the screen 151, as shown in FIG. 9, 2D video is displayed while the 2D video display mode is maintained. However, whether the video display area is to be set in the 2D video display mode or in the 3D video display mode may be determined based on the data structure of 3D video data and the position where the video display area falls out of the screen 151.

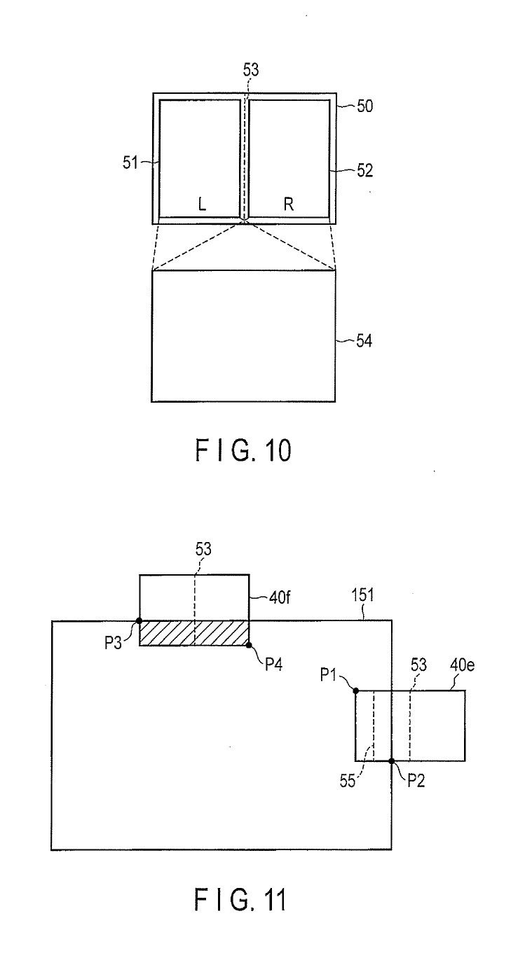

FIG. 10 shows the data structure of 3D video data of a side-by-side format in which left-eye video data 51 and right-eye video data 52 are arranged in one frame 50 in a right-and-left direction.

In the case of this data structure, as shown in FIG. 10, left-eye video data 51, which is present on the left side of a center line 53 dividing one frame into left and right parts, and right-eye video data 52, which is present on the right side of the center line 53, are extracted and composited, and display data 54 for 3D video for displaying left-eye video and right-eye video in one frame is generated. The LCD 15A displays video, based on the display data 54 for 3D video which has been generated by the video display module 33.

In this case, as shown in FIG. 11, when a video display area 40e protrudes from the right side of the screen 151, the video processing module 32 outputs to the video display module 33 coordinate information (P1, P2) indicative of a displayable range of the video display area 40e. If the video processing module 32 outputs the 3D video data of the side-by-side format shown in FIG. 10 to the video display module 33, the display data 54 for 3D display is generated and displayed based on the data corresponding to the displayable range. Specifically, the display data 54 for 3D video is generated and displayed based on a center line 55 of the data corresponding to the displayable range, the center line 55 being different from the normal center line 53. In this case, since correct 3D video cannot be displayed, the video display area 40e is set in the 2D video display mode and 2D video is displayed, as described above. The same applies to the case in which the video display area 40e protrudes from the left side of the screen 151.

On the other hand, as shown in FIG. 11, when a video display area 40f protrudes from the upper side of the screen 151, the video processing module 32 outputs to the video display module 33 coordinate information (P3, P4) indicative of a displayable range of the video display area 40f. In this case, the display data 54 for 3D display is generated and displayed based on based on a center line 55 of the data corresponding to a displayable range. Specifically, since the display data 54 for 3D video is generated and displayed based on the left-eye video data 51 and right-eye video data 52 corresponding to the displayable range, correct 3D video can be displayed in the displayable range (P3, P4) in the video display area 40f. The same applies to the case in which the video display area 40f protrudes from the lower side of the screen 151.

Thus, in the case where the data structure of 3D video data is the side-by-side format, if the area position determination module 38 determines that the video display area 40e protrudes from the left side or right side of the screen 151, the area position determination module 38 notifies the video processing module 32, thereby setting the video display area 40e in the 3D video display mode. On the other hand, even when the area position determination module 38 determines that the video display area 40e protrudes from the upper side or lower side of the screen 151, the area position determination module 38 does not notify the video processing module 32 that the video display area 40e protrudes from the upper side or lower side of the screen 151. Accordingly, the video display area 40f remains in the 3D video display mode, and the 3D video can continuously be displayed.

Similarly, in the case where the data structure of 3D video data is a top-and-bottom format in which left-eye video data and right-eye video data are arranged in one frame in a top-and-bottom direction, the video display area 40f is set in the 2D video display mode when the video display area 40f protrudes from the upper side or lower side of the screen 151, and the video display area 40e is kept in the 3D video display mode when the video display area 40e protrudes from the right side or left side of the screen 151.

As has been described above, whether the video display area is to be set in the 2D video display mode or 3D video display mode is determined based on the data structure of 3D video data and the position where the video display area falls out of the screen 151. Thereby, even when the video display area is moved to a position protruding from the screen 151, the display of the 3D video can be continued as long as possible.

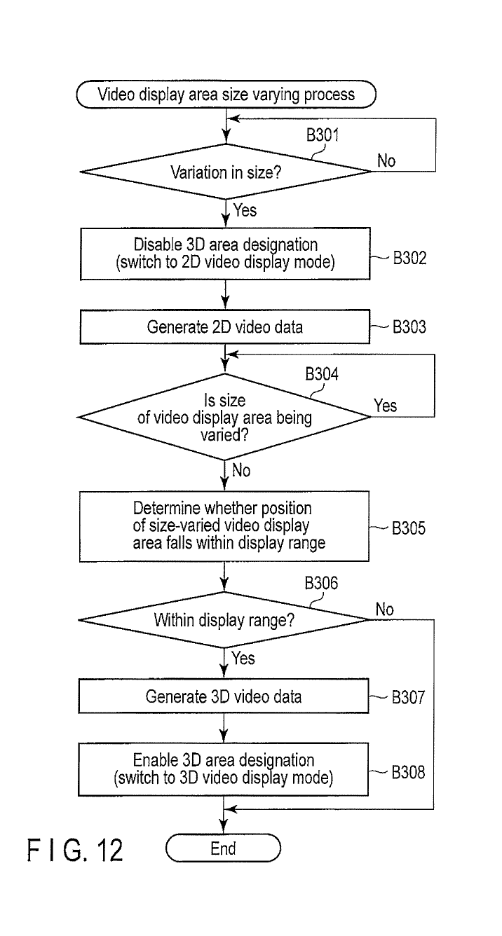

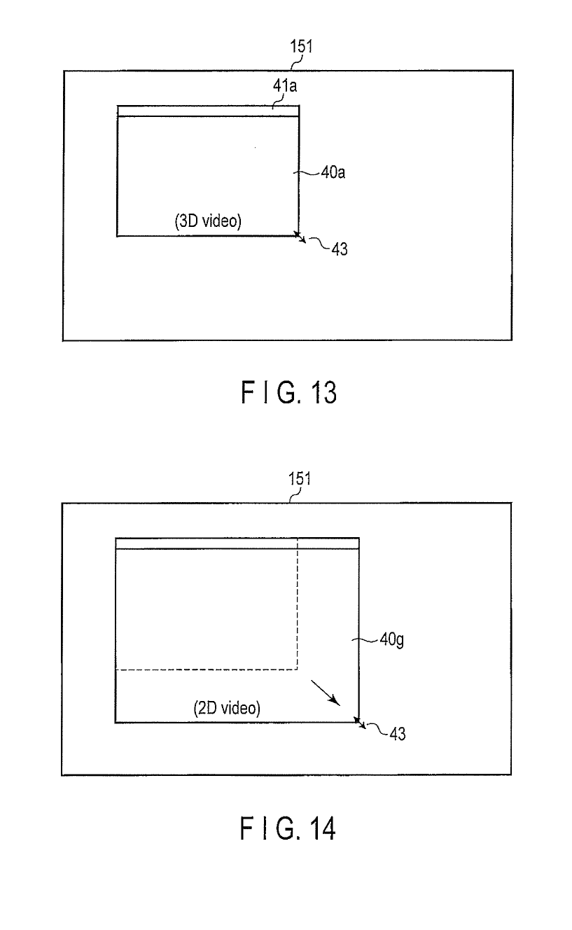

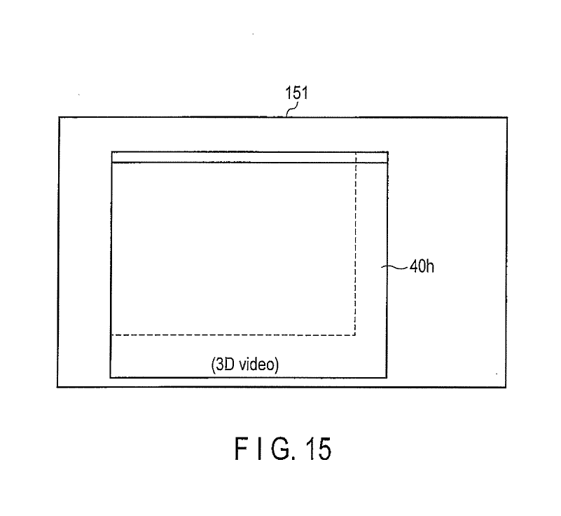

Next, referring to a flow chart of FIG. 12, a description is given of an example of the procedure of a video display area size varying process. FIG. 13, FIG. 14 and FIG. 15 show screen examples of the LCD 15A for describing the video display area moving process.

In the screen example shown in FIG. 13, like the example of FIG. 6, the video display area 40a for displaying video is set on a partial area of the screen 151. When the pointer 42 is set at a predetermined position of the video display area 40a, for example, at any one of the four corners or sides of the video display area 40a, the pointer 42 changes to a pointer 43, which indicates a transition to a mode of varying the size of the video display area 40a. The size of the video display area 40a can be varied by executing a drag operation of the pointer 43.

Assuming that the video display area size varying process is executed basically similarly with the above-described video display area moving process (FIG. 5), a detailed description of the video display area size varying process is omitted. Specifically, the process of blocks B201 to B208 corresponds to the process of blocks B301 to B308.

In the video display area size varying process, as illustrated in FIG. 14, while the size of a video display area 40g is being varied, the video display mode of the video display area 40g is switched to the 2D video display mode, and 2D video is displayed on the video display area 40g. When the process of varying the size is terminated, as shown in FIG. 15, the video display mode of a size-varied video display area 40h is switched to the 3D video display mode, and 3D video is displayed on the video display area 40h.

In the above-described example, the range of the video display area 40a is varied by the operation of the pointer 42, 43. However, a similar process may be executed in the case of varying the range of the video display area 40a by other operations.

For example, by a predetermined operation on the keyboard 26 or an operation of a button (maximize button, minimize button) provided on the title bar 41a, maximize can be executed to enlarge the video display area 40a to the entirety of the screen 151 or minimize can be executed to close the video display area 40a and put it on the taskbar. By an operation of selecting the video display area 40a that is put on the taskbar, the video display area 40a can be restored to the original range and displayed.

The event detection module 35 detects an event of maximizing/minimizing the video display area 40a or an event of restoring the video display area 40a, which is put on the taskbar, to the original range. Then, while the process of varying the video display area 40a is being executed, the video display mode of the video display area 40a is switched to the 2D video display mode, and 2D video is displayed.

In particular, when the size of the video display area 40a is varied stepwise in response to the event of maximize/minimize, so that the user can recognize the variation of the size of the video display area 40a, it is possible to prevent disordering of video by displaying 2D video on the video display area 40a which is being varied.

The same is applicable to other events of varying the range of the video display area 40a, aside from the event of maximize/minimize.

As has been described above, when the size of the video display area 40a, on which 3D video is displayed, is being varied, the video display mode of the video display area 40a is switched to the 2D video display mode, and 2D video is displayed on the video display area 40g which is being varied in size. When the 2D video is displayed, a process with a great load, such as driving of the lens unit 15B or generation of 3D video data, is needless, so the video displayed in the video display area 40g is not disordered. In short, correct video can continuously be displayed on the video display area 40g which is being moved.

The above description is directed to the case in which video is displayed on the area (display window) that is set on the 3D display 15. However, the same process can be executed when 3D still images are displayed.

In addition, the above description is directed to the 3D display 15 which displays two-parallax 3D video using left-eye video data and right-eye video data. However, the embodiment is applicable to displays which display 3D video of more than two parallaxes.

All the procedures of the video reproduction process and the display control process according to the embodiment may be executed by software. Thus, the same advantageous effects as with the embodiment can easily be obtained simply by installing the video content reproduction program 13B, which executes the procedures of the video reproduction process and the display control process, into an ordinary computer through a computer-readable storage medium which stores the program, and executing this program. Examples of the computer-readable storage medium include a magnetic disk (e.g. a flexible disk, a hard disk), an optical disk (e.g. a CD-ROM, a DVD) and a semiconductor memory. The program may also be transmitted via communication media and provided to the computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display with a screen, an area of a part of the screen being settable in one of a three-dimensional video display mode of displaying three-dimensional video and a two-dimensional video display mode of displaying two-dimensional video;
a detection module configured to detect a variation of a range of the area;
a switch module configured to switch the area to the two-dimensional video display mode, in a case where the detection module detects the variation of the range of the area when the area is set in the three-dimensional video display mode; and
a video display control module configured to display, on the area, video corresponding to one of the three-dimensional video display mode and the two-dimensional video display mode.

2. The electronic apparatus of claim 1, wherein the switch module is configured to switch the area to the three-dimensional video display mode when the variation of the range of the area is terminated.

3. The electronic apparatus of claim 1, further comprising an area position determination module configured to determine whether an entirety of the area falls within the screen,
wherein the switch module is configured to switch the area to the two-dimensional video display mode when the entirety of the area fails to fall within the screen.

4. The electronic apparatus of claim 1, wherein the display is configured such that a lens unit is laid over a video display surface, and the lens unit comprises a plurality of lenses for emitting, in predetermined directions, a plurality of light rays corresponding to a plurality of pixels comprised in video.

5. The electronic apparatus of claim 1, wherein the variation of the range of the area is indicative of a movement of the area.

6. The electronic apparatus of claim 1, wherein the variation of the range of the area is indicative of a variation in size of the area.

7. The electronic apparatus of claim 3, wherein the switch module is configured to switch the area to one of the two-dimensional video display mode and the three-dimensional video display mode, based on a data structure of the three-dimensional video data and a position where the area protrudes from the screen.

8. A display control method comprising:
setting an area of a part of a display screen in one of a three-dimensional video display mode of displaying three-dimensional video and a two-dimensional video display mode of displaying two-dimensional video;
detecting a variation of a range of the area;
switching the area to the two-dimensional video display mode, in a case where the variation of the range of the area is detected when the area is set in the three-dimensional video display mode; and
displaying, on the area, video corresponding to one of the three-dimensional video display mode and the two-dimensional video display mode.

9. A computer-readable, non-transitory storage medium having stored thereon a computer program which is executable by a computer, the computer program controlling the computer to execute functions of:
setting an area of a part of a display screen in one of a three-dimensional video display mode of displaying three-dimensional video and a two-dimensional video display mode of displaying two-dimensional video;
detecting a variation of a range of the area;
switching the area to the two-dimensional video display mode, in a case where the variation of the range of the area is detected when the area is set in the three-dimensional video display mode; and
displaying, on the area, video corresponding to one of the three-dimensional video display mode and the two-dimensional video display mode.
